(19) United States
(12) Patent Application Publication
(10) Pub. No.: US 2018/0127114 A1
(43) Pub. Date: May 10, 2018

(54) Geolunar Shuttle

(71) Applicant: Robert Salkeld, Santa Fe, NM (US)

(72) Inventor: Robert Salkeld, Santa Fe, NM (US)

(21) Appl. No.: 15/460,055

(22) Filed: Mar. 15, 2017

(51) Int. Cl. B64G 1/14; B64G 1/40; B64G 1/62; B64G 1/00

(52) U.S. Cl. CPC B64G 1/14; B64G 1/402; B64G 1/007; B64G 1/62; B64G 1/005; B64G 1/401

(57) ABSTRACT

A vehicle and method enabling propulsive flight from the Earth's surface to and from the Moon's surface returning to horizontal Earth landing along an airstrip. This reusable geolunar shuttle vehicle can employ external drop tanks, and function as the final propulsive stage of a multi-stage vehicle which can be: 1) expendable, reusable or party reusable; 2) ground-launched, sea-launched, or air-launched; 3) single-launched or multiple-launched with assembly/refueling en route. The geolunar shuttle can employ axial or ventral propulsion using current operational single-fuel engines or dual-fuel engines providing enhanced system performance. The geolunar shuttle can be crewed or not, and can be internally configured to carry personnel, cargo, or a mix of both. The geolunar shuttle can optionally be used for low earth orbit and far space, including Earth escape missions.

### BACKGROUND OF THE INVENTION

### Field of the Invention (Technical Field)

Embodiments of the present invention are related to reusable rocket vehicle systems to perform shuttle missions between the surfaces of the Earth and the Moon.

### BACKGROUND OF THE INVENTION

Note that the following discussion refers to a number of publications and references. Discussion of such publications herein is given for more complete background of the scientific principles and is not to be construed as an admission that such publications are prior art for patentability determination purposes.

The term geolunar shuttle means a reusable vehicle to carry cargo from the Earth's surface to and from the Moon's surface. Previous designs for geolunar shuttles include: 1) axial tail-sitting Moon landing propulsion (egress/access awkward); 2) all oxygen/hydrogen propulsion (hydrogen boiloff problem during Moon surface stay-time); 3) assembly/refueling in low-Earth orbit (performance penalty).

### SUMMARY OF THE INVENTION

An embodiment of the present invention is a method for performing spaceflight, the method comprising launching a reusable vehicle for traveling to the moon and returning to earth on a first launcher; launching pre-filled propellant tanks on a second launcher; and combining the vehicle and the propellant tanks in or beyond earth orbit. The combining step is preferably performed in low earth orbit (LEO) or moon transfer orbit (MTO). The amount of propellant in the propellant tanks is preferably sufficient to enable the vehicle to land on the moon's surface, lift off from the moon's surface, and return to the earth's surface without refueling. The method preferably further comprises throttling throttleable engines of the vehicle during lunar descent. The method optionally comprises the vehicle landing in a horizontal attitude on the moon and/or earth using ventral propulsion. The vehicle is optionally ventrally propelled for moon takeoff and landing, and axially propelled for injection into MTO. The method preferably comprises operating dual fuel engines in reverse use mode and optionally comprises landing the vehicle on skids. The first launcher and/or the second launcher optionally comprise a Delta IV Heavy Launcher.

Another embodiment of the present invention is a vehicle for landing on and taking off from the moon, the vehicle comprising dual fuel engines operated in reverse use mode. The vehicle preferably comprises external tanks capable of holding sufficient propellant to enable the vehicle to land on the moon's surface, take off from the moon's surface, and return to the earth's surface. The vehicle preferably comprises one or more throttleable engines and a controllable throttling system. The vehicle is preferably launchable from a Space Launch System (SLS), a reusable global launcher, an air launch platform, or a sea launch platform. The vehicle is optionally the payload of a two stage expendable launch vehicle. The vehicle optionally comprises ventral propulsion for horizontal attitude landing on the moon and/or earth. The vehicle is optionally ventrally propelled for moon takeoff and landing, and axially propelled for injection into MTO. The vehicle optionally comprising skids for landing.

Another embodiment of the present invention is a vehicle for use as a booster, the vehicle comprising an aircraft launchable at sea, the aircraft having sufficient thrust to provide a 45° launch for a payload at an altitude greater than 30,000 feet. The vehicle preferably comprises pontoons sufficient to provide flotation for a seaplane weighing over four million pounds. The vehicle preferably comprises one or more rocket engines, optionally three three tail-mounted RD-180 rocket engines. The vehicle is preferably configured to be fueled and serviced from shipborne or submarine facilities. The payload optionally comprises a spacecraft, a geolunar shuttle, a ballistic missile, a cruise missile, or a drone.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings and the dimensions therein are only for the purpose of illustrating certain embodiments of the invention and are not to be construed as limiting the invention.

In the drawings:

FIG. 1A shows an axially propelled geolunar shuttle of the present invention comprising external propellant tanks. FIG. 1B shows replacing the payloads of two upgraded Delta IV Heavy Earth launchers with the geolunar shuttle detailed in FIG. 1A and external fuel tanks, which rendezvous in Moon transfer orbit (MTO), which is any transfer orbit that enables a space vehicle to reach the moon, or any other orbit beyond earth orbit, for assembly of the shuttle and the propellant tanks during the approximately four-day transit from Earth to the Moon. The Earth-Moon surface-Earth cargo is 4 people plus 1.5 tons. The gross liftoff weight of the top launcher is 989 tons; the gross liftoff weight of the bottom launcher is 816 tons.

FIG. 2A shows a ventrally propelled geolunar shuttle of the present invention, comprising external propellant tanks. FIG. 2B shows the geolunar shuttle and external tanks of FIG. 2B replacing the payloads of two upgraded Delta IV Heavy Earth launchers, which rendezvous in low Earth orbit (LEO) (220 nautical miles) for assembly of the shuttle and the propellant tanks before injection into MTO. The gross liftoff weight of the top launcher is 920 tons; the gross liftoff weight of the bottom launcher is 967 tons.

FIG. 3A shows a ventrally propelled geolunar shuttle of the present invention. FIG. 3B shows the shuttle replacing the payload of a Space Launch System (SLS) Earth launcher having a gross liftoff weight of 3215 tons for direct unrefueled geolunar shuttle flight. The cargo for Earth-Moon surface-Earth travel is 4 people plus 1 ton.

FIG. 4A shows a geolunar shuttle of the present invention axially propelled for injection into MTO, and ventrally propelled for Moon landing and takeoff (MLTO), for direct unrefueled geolunar shuttle flight. FIG. 4B shows the shuttle replacing the SLS upper stage and payload. The SLS has a gross liftoff weight of 3254 tons. The cargo for Earth-Moon surface-Earth travel is 6 people plus 4 tons. FIG. 4C shows an axially propelled adaptation (detailed in the inset of FIG. 4A) replacing the upper stage and payload of a standard Delta IV Heavy Earth launcher having a gross liftoff weight of 835 tons for LEO shuttle missions. The cargo for Earth-LEO-Earth travel is 2 people plus 10 tons.

FIG. 5A shows a geolunar shuttle of the present invention that is ventrally propelled for an entire personnel-plus-cargo geolunar shuttle mission. FIG. 5B shows the shuttle replacing the SLS Earth launcher upper stage and payload, resulting in a gross liftoff weight of 3246 tons. The cargo for Earth-Moon surface-Earth travel is 6 people plus 5 tons. FIG. 5C shows a cargo only version (detailed in the inset of FIG. 5A) having a crew of two. In this embodiment the gross liftoff weight is 3252 tons and the cargo for Earth-Moon surface-Earth travel is 2 people round trip plus 11 tons one way.

FIG. 6A shows a ventrally propelled embodiment of the present invention similar to that shown in FIGS. 2 and 3 as the payload of a two-stage expendable launch vehicle, for air launch from a large subsonic landplane (see U.S. Pat. No. 9,139,311, incorporated herein by reference). The main tank has a diameter of 27.5 feet and rocket-assisted pullup is used (launch at 60,000 ft. altitude, 45° flight path angle). FIG. 6B shows a reference aircraft.

FIG. 7A shows the concept of FIG. 6A modified for subsonic seaplane air launch. The rolling gear pods of the previous configuration preferably contain sufficient volume so that they can be modified as shown to pontoons to provide flotation for a 4.4 million lb. seaplane. FIG. 7B shows a reference aircraft.

FIGS. 8A and 8B show rocket engine scale and engine cycle schematics respectively for mixed-mode, dual-fuel, tripropellant engine designs.

FIG. 9A shows a dual fuel ventrally propelled embodiment of the present invention comprising external propellant tanks. FIG. 9B shows the shuttle and external tanks replacing the payloads of two upgraded A IV Heavy Earth launchers. The top launcher has a gross liftoff weight of 972 tons and the bottom launcher has a gross liftoff weight of 816 tons. The Earth-Moon surface-Earth cargo is 4 people plus 1 ton.

FIG. 10A shows a ventrally propelled, fully reusable embodiment of the present invention for personnel transport. FIG. 10B shows the shuttle as the payload of a reusable global launcher (RGL) as described in U.S. Pat. No. 9,139,311. The gross liftoff weight of the RGL is 3803 tons and the Earth-Moon surface-Earth cargo is 6 people plus 1000 lbm.

FIG. 11A shows an embodiment of the present invention for heavy end-load cargo transport. FIG. 11B shows the shuttle as the payload of a RGL. The gross liftoff weight of the RGL is 5279 tons and the Earth-Moon surface-Earth cargo is 2 people plus 17 t.

### DETAILED DESCRIPTION OF THE INVENTION

Embodiments of the present invention are vehicles for transporting personnel and/or cargo from Earth's surface to and from the Moon's surface and return to Earth. The vehicle of the present invention may or may not carry an onboard operating crew and the cargo may or may not include personnel, and is preferably capable of Earth return by horizontal airstrip landing. The geolunar shuttle vehicle is preferably configured with high fineness ratio of 7-8 for hypersonic lift-to-drag of 3-4 for maneuvering escape re-entry and horizontal airstrip landing, as described in U.S. Pat. Nos. 5,090,692 and 8,534,598, incorporated herein by reference. Embodiments of the present invention comprise ventral propulsion for both Moon landing/ascent and main Earth-Moon transfer; dual-fuel (oxygen/hydrocarbon/hydrogen) Moon landing/ascent as well as main Earth-Moon transfer propulsion; reverse use of dual-fuel Moon landing/liftoff engines to eliminate hydrogen boiloff during Moon surface stay; assembly/refueling during Earth-Moon transfer (3-4 days) in Moon transfer orbit (MTO); skid-type gear for both vertical Moon landing and horizontal Earth airstrip landing; and conversion to seaplane capability for air launch to expand launch flexibility. This combination has the benefits of increased performance, flexibility and reusability using existing rocket and turbofan engines; and further increased performance, flexibility and reusability using designed dual-fuel liftoff and space rocket engines.

The above proposed innovations can be incorporated into geolunar shuttle concepts which can vary widely, depending on, for example, Earth launcher, shuttle size, propulsion mode, propulsion vector, location of any in-space assembly/refueling, and/or manifest (e.g. manned/unmanned and/or cargo). These particular examples, and specific options within each of them, can be treated as ordinates of a seven-dimensional concept matrix having thousands of meaningful cells, as exemplified in Table 1.

| ORDINATE | OPTIONS | SUBOPTIONS |
|---|---|---|
| Earth Launcher | Ground Launch (3) | Delta IV Heavy (ΔIVH) |
| (3 + 2 = 5) | | Space Launch System (SLS) |
| | | Reusable Global Launcher |
| | | (RGL- see 9, 139, 311) |
| | Air Launch (2) | Landplane |
| | | Seaplane |
| Size | Replace Payload (P/L) (1) | — |
| (1 + 1 = 2) | Replace Upper Stage + P/L (1) | |
| Propulsion Mode | Single-fuel (1) | — |
| (1 + 2 = 3) | | |
| | Dual-fuel (2) | Two single-fuel engines |
| | | Dual-fuel engines |
| Propulsion Vector | Axial (1) | — |
| (1 + 2 + 1 = 4) | | |
| | Ventral (2) | Moon landing/take off (MLTO) |
| | | Main including MLTO |
| | Axial + Ventral (1) | — |
| Assembly Location | None (1) | — |
| (1 + 5 = 6) | | |
| | Multiple (5) | Low Earth Orbit (LEO) |
| | | Moon Transfer Orbit (MTO) |
| | | LaGrange 1 (L-1) |
| | | Low-Moon Orbit (LMO) |
| | | Moon surface (MS) |
| Refueling Location | As above for Assembly Location | |
| (1 + 5 = 6) | | |
| Manifest | Multiple (3) | Personnel only |
| (3) | | Personnel + Cargo |
| | | Cargo only (unmanned) |

Ten geolunar shuttle concepts are presented herein to illustrate the diversity in this kaleidoscope of possibilities. Of the ten geolunar shuttle concepts shown, the first seven use rocket and turbofan engines which are operational (RS-25; RS-68; RL-10; GEM-60; GE90-115 B) or substantially developed (J 2X; RL and MB-60). The last three use dual-fuel engines which have been designed but not developed, a space engine (O₂/MH/H₂) and an Earth liftoff engine (O₂/C₃H₈/H₂).

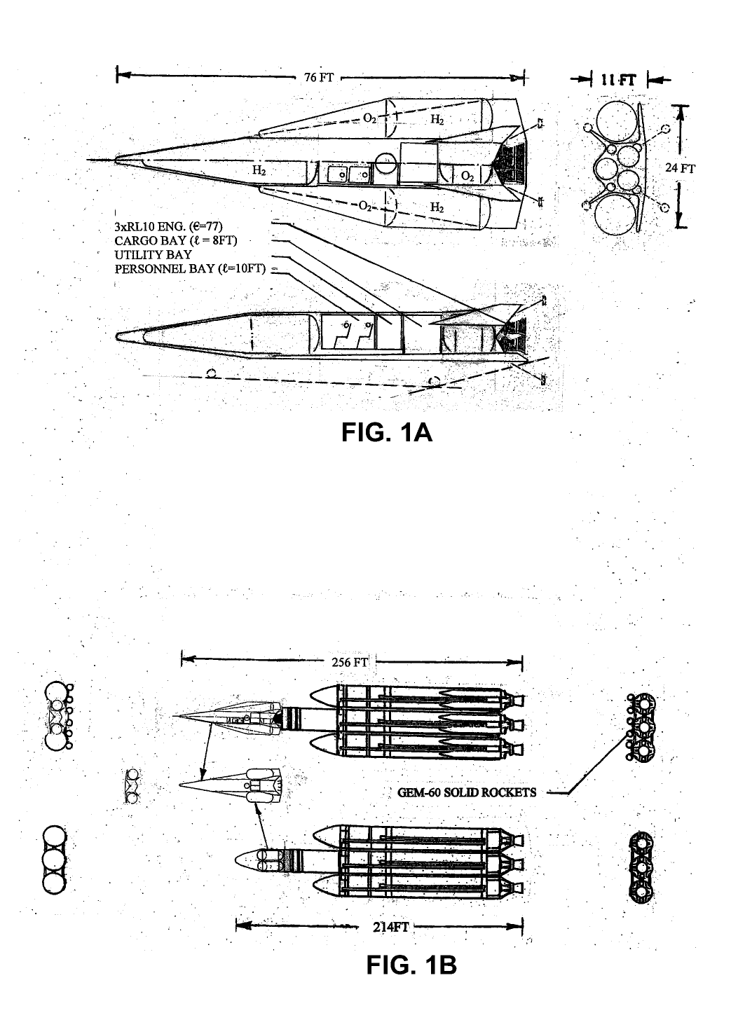

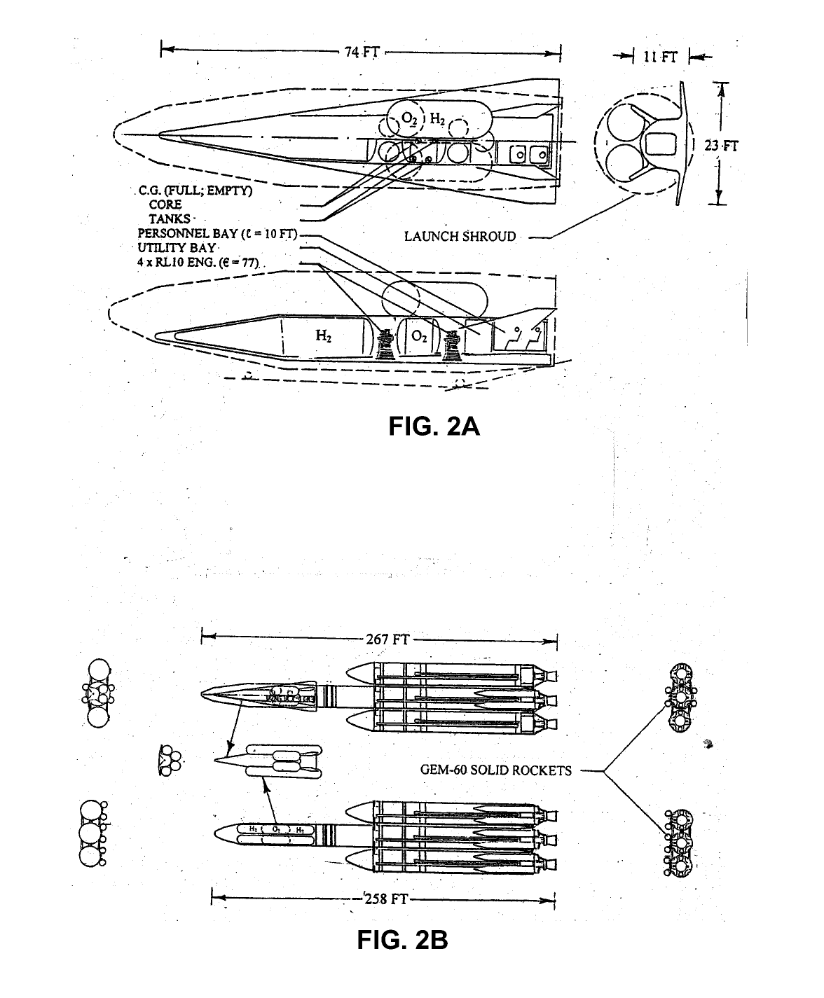

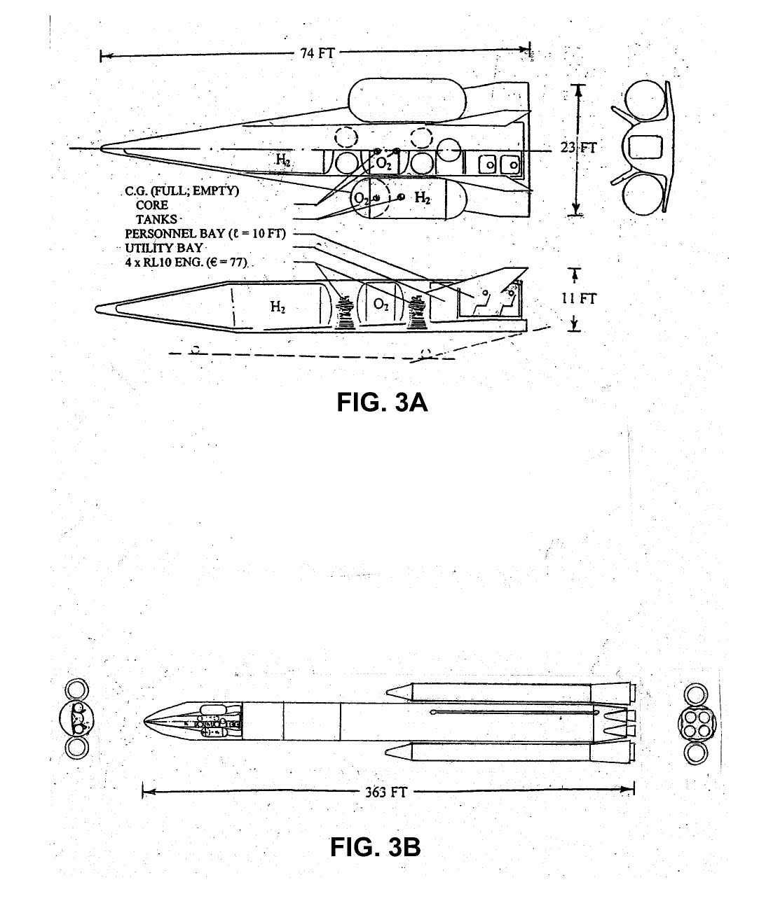

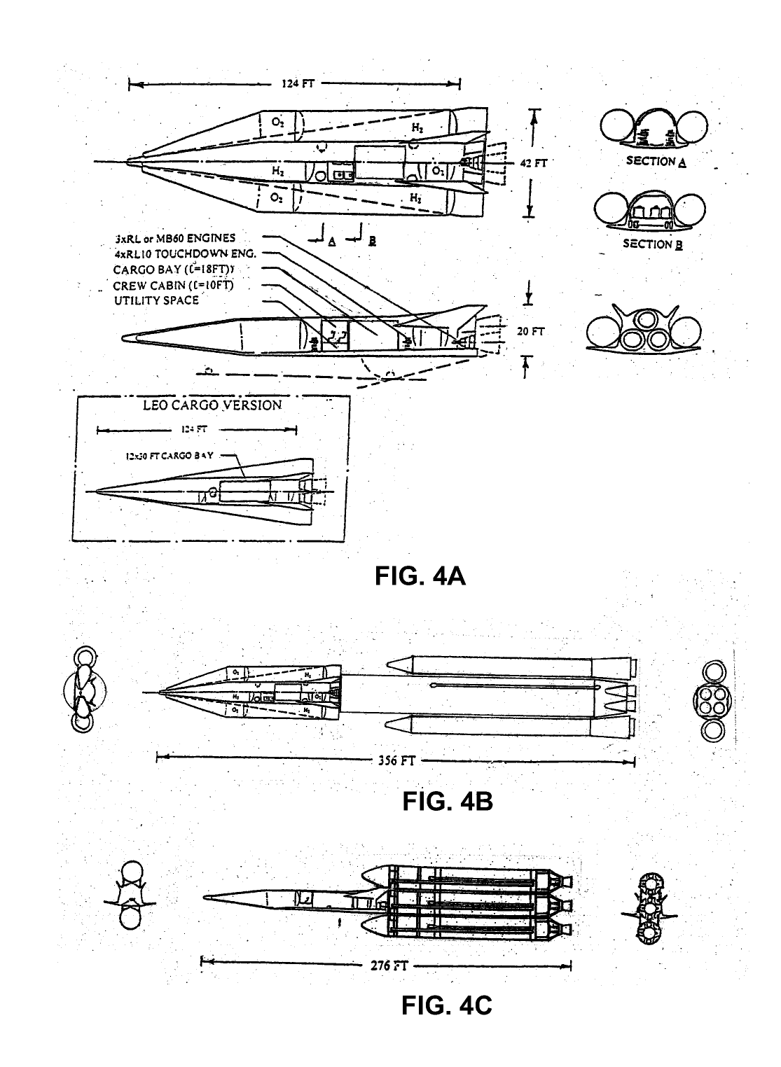

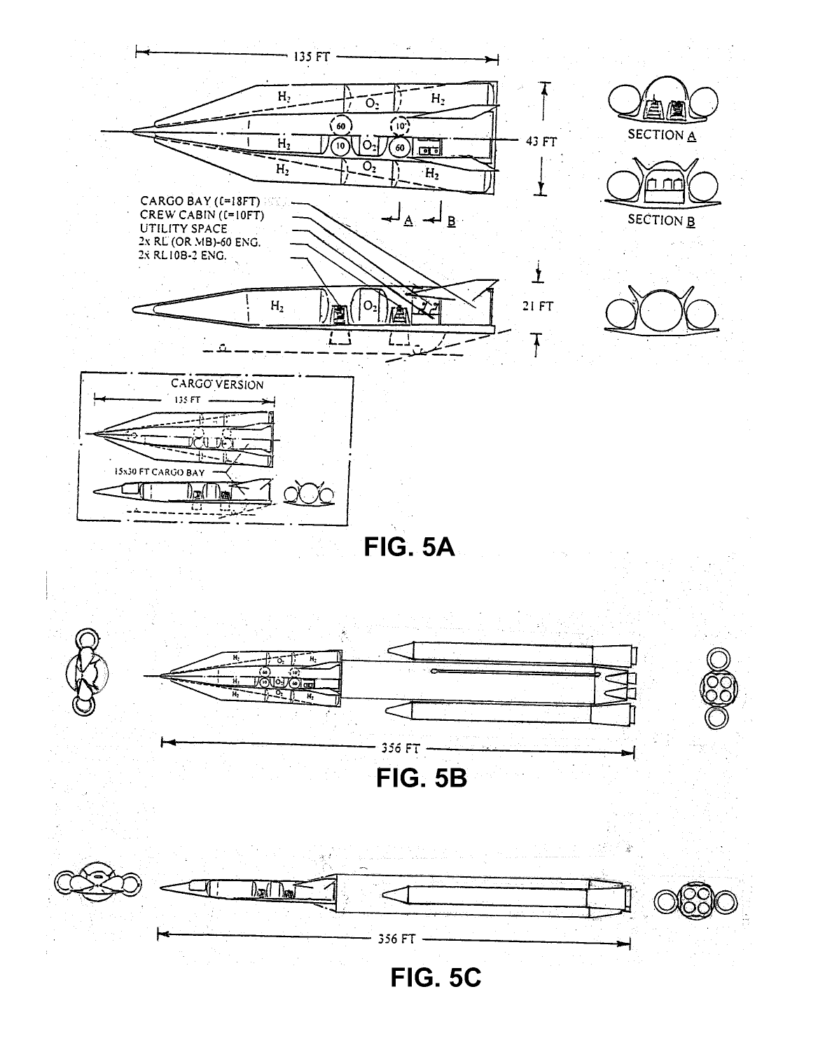

Embodiments of the present invention comprise ventral propulsion, as shown in FIGS. 1-7 and 9-11, which can be employed not only for Moon landing and take-off, but also as main propulsion for final Earth ascent and injection into Moon transfer orbit (MTO). The total thrust of the ventral engines, which produce thrust substantially perpendicular to the axis of the shuttle, at ignition is as required to provide at least a 0.2 thrust: vehicle weight ratio, considered adequate after clearance of most of the atmosphere during Earth ascent, and more than adequate for vertical Moon landing and take-off. The benefits of ventral propulsion geometry are: 1) more surface area for propulsion than for tail-mounted engines; 2) more engines for engine-out capability; 3) horizontal attitude Moon landing for safer, more efficient Moon surface access, for personnel and/or cargo; and 4) more forward vehicle center of gravity for improved aerodynamic stability at Earth re-entry and landing.

Propellant feed for ventral propulsion can be accomplished by slight canting of the tanks, slosh baffles, and proper design at the end of the tank, of a collecting sump to deliver the propellants to the engines.

Embodiments of the present invention comprise a plurality of Moon landing and takeoff engines, preferably about three or four, considered reasonable in view of the fact that the Apollo program (1969-1973) accomplished six geolunar shuttle missions with only one Moon landing/takeoff engine. Also the availability of multiple shuttle engines confers flexibility to correct for engine-out situations by differential thrust through appropriate engine throttling.

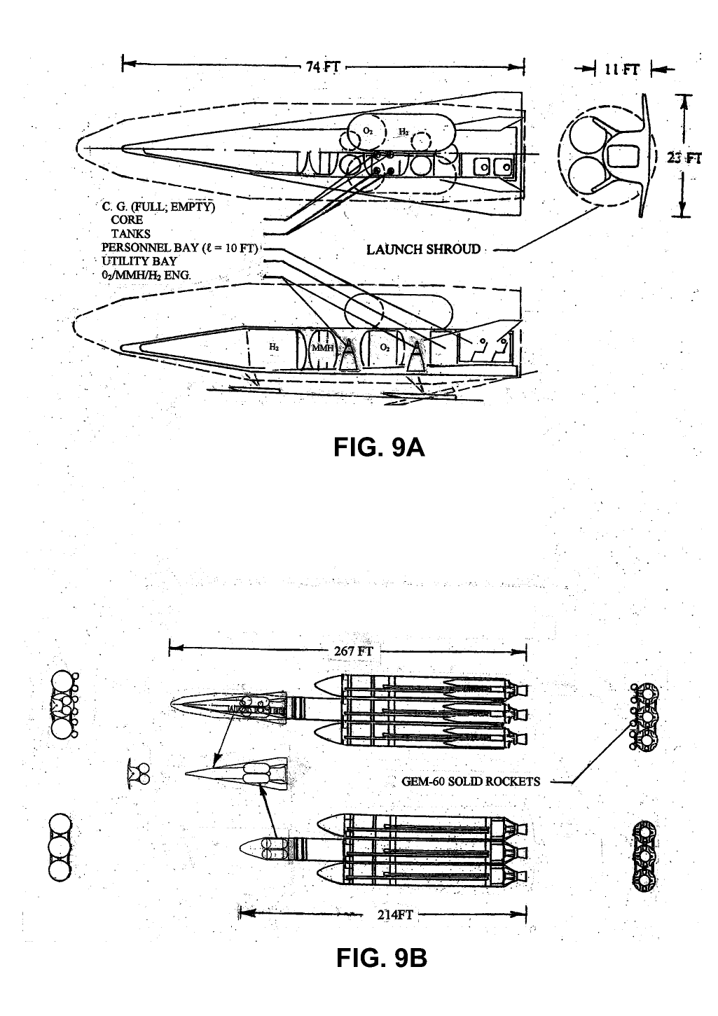

Embodiments of the present invention are assembled/refueled in Moon transfer orbit (MTO), as shown in FIGS. 1 and 9. This confers at least four new benefits: 1) elimination of the performance penalties incurred by injection into rendezvous, and ejection from LEO; 2) elimination of time spent in LEO during which the far space shuttle is vulnerable to simple inexpensive ground fire; 3) reduction of geolunar trip time and associated life support and power weight requirements; and 4) simplification, reliability and safety improvement for the overall transportation mission.

Performance and configurations of the Delta IV Heavy launch and its upgrades, shown in FIGS. 1, 2, 4, and 7 are known. Currently operational Delta IV Heavy launch complexes on both Atlantic and Pacific U.S. coasts could, with suitable modifications, enable synchronized launches of upgraded vehicles for assembly in LEO or MTO as shown in FIGS. 2, 1, and 9 respectively. The vehicle parameters for the embodiments shown in FIGS. 1A, 2A, 3A, 4A, and 5A are listed in Tables 2-6, respectively.

TABLE 2

| | VEHICLE ELEMENT | | |
|---|---|---|---|
| VEHICLE ELEMENT | | EXTERNAL TANKS | |
| PARAMETER | CORE | AT MTO | AT LAUNCH |
| Personnel (4) | 1,000 | — | — |
| ECLSS (10 days) | 2,000 | — | — |
| Mission equipment | 3,000 | — | — |
| Gross start weight, lbm | 55,800 | 30,900 | 51,500 |
| Dry weight, lbm | 17,000^{a} | 1,200 | 2,000 |
| Engines | 3xRL10(ϵ = 77) | — | — |
| Re-entry planform loading, | 28.7 | | |
| (w/4 crew), lbm ft² | | | |
| Re-entry cross range, n · mi. | ±4,500 | — | — |

^{a}Incl. 15% margin

TABLE 3

| | VEHICLE ELEMENT | | |
|---|---|---|---|
| VEHICLE ELEMENT | | EXTERNAL TANKS | |
| PARAMETER | CORE | TOP (2) | SIDE (2) |
| Personnel (4) | 1,000 | — | — |
| ECLSS (10 days) | 2,000 | — | — |
| Mission equipment | 2,000 | — | — |
| Gross start weight, lbm | 54,300 | 30,600 | 96,100 |
| Dry weight, lbm | 17,500^{a} | 1,200 | 3,800 |
| Engines | 4xRL10(ϵ = 77) | — | — |
| Re-entry planform loading, | 26.8 | — | — |
| (w/4 crew), lbm ft² | | | |
| Re-entry cross range, n · mi. | ±4,500 | — | — |

^{a}Incl. 15% margin

TABLE 4

VEHICLE ELEMENT

| VEHICLE ELEMENT | | EXTERNAL |
|---|---|---|
| PARAMETER | CORE | TANKS |
| Personnel (4) | 1,000 | — |
| ECLSS (10 days) | 2,000 | — |
| Mission equipment | 2,000 | — |
| Gross start weight, lbm | 54,300 | 30,600 |
| Dry weight, lbm | 17,500^{a} | 1,200 |
| Engines | 4xRL10(ϵ = 77) | — |
| Re-entry planform landing, | 26.8 | — |
| (w/4 crew), lbm ft² | | |
| Re-entry cross range, n · mi. | ±4,500 | — |

^{a}Incl. 15% margin

TABLE 5

| | VEHICLE | | |
|---|---|---|---|
| | MOON LANDER SHUTTLE | | |
| | WITH SLS | | LEO^{a} SHUTTLE WITH |
| PARAMETER | CORE | EXT. TANKS | Δ IV HEAVY |
| Personnel (6: 2) | 1,500 | — | 500 |
| Env. contr/life support (10 days), lbm | 3,000 | — | 1,000 |
| Cargo, round trip | 7,300 | — | 19,400 |
| Gross start mass, lbm | 223,800 | 524,900 | 157,400 |
| Dry mass less cargo, lbm | 53,500^{b} | 21,100 | 41,800^{b} |
| Engine (s) | | | |
| RL(orMB)-60 | 3 | — | — |
| RL10(ϵ = 77) | 4 | — | — |
| RL10B-2 | — | — | 2 |
| Re-entry planform landing | 23 | — | 2.5 |
| (RT cargo), lbm/ft² | | | |
| Cargo bay, ft | 12 × 18 | — | 12 × 30 |
| Cargo density (RT), lbm/ft³ | 3.6 | — | 7.9 |
| Re-entry cross range, n · mi. | ±4,500 | — | ±4,500 |

^{a}220 n · mi.; 28.7°
^{b}Incl. 15% margin

TABLE 6

| | VEHICLE | | |
|---|---|---|---|
| | CORE VEHICLE | | EXTERNAL |
| PARAMETER | PERS. + CARGO | CARGO | TANKS |
| Personnel (6; 2) | 1,500 | 500 | — |
| Env. contr/life support (10 days), lbm | 3,000 | 1,000 | — |
| Cargo, lbm | 9,300 | 22,400 | — |
| Gross start mass, lbm | 224,600 | 234,300 | 515,600 |
| Dry mass less cargo, lbm | 52,900* | 49,700 | 20,600 |
| Engine | | | |
| RL(orMB)-60 | 2 | 2 | — |
| RL10B-2 | 2 | 2 | — |
| Re-entry planform loading, lbm ft² | 23 | 16 | — |
| Cargo bay, ft | 15 × 18 | 15 × 30 | — |
| Cargo density, lbm/ft³ | 2.9 (RT)^{a} | 3.8 (OW)^{b} | — |
| Re-entry cross range, n · mi. | ±4,500 | ±4,500 | — |

*Incl. 15% margin
^{a}round trip
^{b}one way up

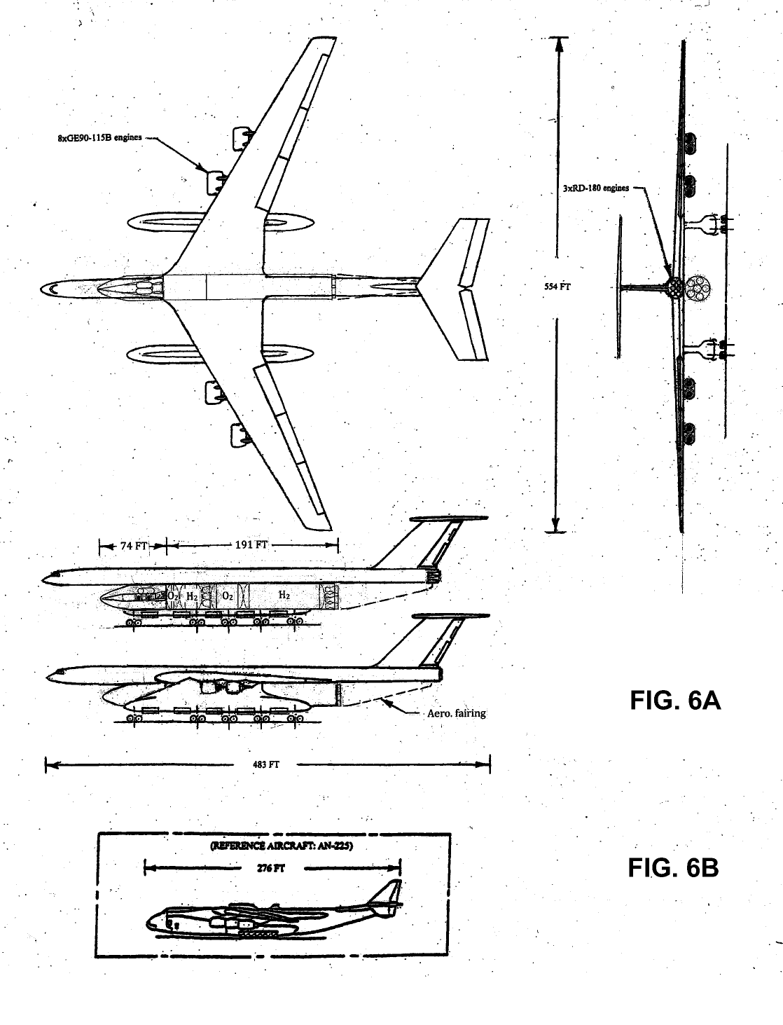

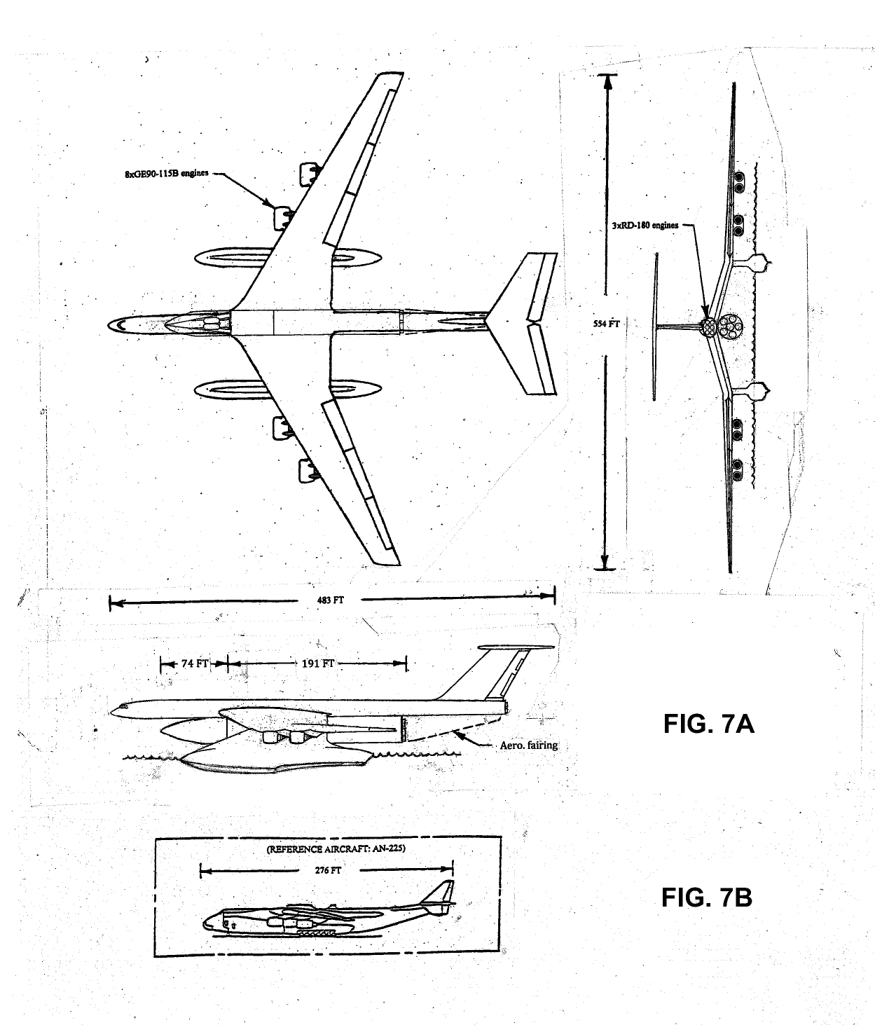

For the air-launch concepts shown in FIGS. 6 and 7, airbreathing takeoff thrust is preferably provided by eight GE90-115B turbofan engines each of which can produce a maximum sea level thrust of 122,965 lbf. For seaplane takeoff this can be augmented by the three tail-mounted RD-180 rocket engines as shown in FIG. 7, each of which can provide a sea level thrust of 859,800 lbf. Advantages of seaplane operations include not being limited to a few very large heavy-rated airstrips, and flexibility to be fueled and serviced from shipborne facilities across global locations, permitting a wide freedom of launch azimuths and orbital inclinations. When a seaplane is used as a booster, the seaplane preferably comprises adequate thrust to provide a zoom or pullup launch for the shuttle payload at high altitude. For example, at an altitude of approximately 30,000-40,000 feet (or even as high as 60,000-70,000 feet) the shuttle rocket engines (primary purpose) are ignited, then, if it is not already, the booster orients itself into a 45 degree attitude to launch the shuttle in a 45 degree flight path.

Furthermore, the seaplane can rendezvous with a submarine as well as a surface ship. If the seaplane as well as its payload is fueled at the rendezvous, it could then proceed to make a launch from any point on Earth, at any azimuth, regardless of diplomatic over flight restrictions if on a military mission. The rendezvous ship, or submarine, can transport all of the launch propellant, seaplane fuel, electronics and personnel needed to support and control a space launch, and confining these resources to shipboard should substantially reduce the “bottom of the iceberg” of infrastructure costs inevitably associated with the bureaucratic sprawl of land-based space launch complexes. The seaplane can be of any size and be used as a booster for less energetic missions than space launch, such as a mobile launch platform for ballistic or cruise missiles, or drones. Such a booster could also be used for space missions other than lunar landing and return. Vehicle parameters for the embodiments shown in FIGS. 6-7 are listed in Tables 7-8 respectively.

TABLE 7

| | | GLS BOOSTER | | GEOLUNAR |
|---|---|---|---|---|
| | | Diameter: 27.5 pt. | | SHUTTLE |
| PARAMETER | AIRCRAFT | STAGE 1 | STAGE 2 | GLS |
| Nominal payload, lbm | 2,200,00 | — | — | — |
| Crew | 7 | — | — | 4 (10 days) |
| Cargo, lbm | — | — | — | 2,000^{a} |
| Gross liftoff mass, lbm | 4,400,000 | 1,714,800 | 403,200 | 83,900 |
| Dry mass less engines, lbm | 1,217,100 | 139,000 | 28,200 | 16,700^{b} |
| Engines, lbm | | | | |
| 8xGE90-115B | 154,520 | — | — | — |
| 3xRD-180 | 37,715 | — | — | — |
| 6xRS-25D | — | 46,464 | — | — |
| 4XRL(MB)-60 | — | — | 4,400 | — |
| 4xRL10(ε = 77) | — | — | — | 1,500 |
| Re-entry planform loading, lbm/ft² | — | — | — | 26.8 |
| Cargo bay, ft | — | — | — | 8 × 10 |
| Cargo density, lb/ft³ | — | — | — | 8.0 |
| Re-entry crossrange, n · mi. | — | — | — | ±4,500 |

^{a}Roundtrip: Earth--Moon surface--Earth
^{b}Incl. 15% margin

TABLE 8

| | | GLS BOOSTER | | GEOLUNAR |
|---|---|---|---|---|
| | | Diameter: 27.5 pt | | SHUTTLE |
| PARAMETER | AIRCRAFT | STAGE 1 | STAGE 2 | GLS |
| Nominal payload, lbm | 2,200,200 | — | — | — |
| Crew | 7 | — | — | 4 (10 days) |
| Cargo, lbm | — | — | — | 2,000^{a} |
| Gross liftoff mass, lbm | 4,400,000 | 1,714,800 | 403,200 | 83,900 |
| Dry mass less engines, lbm | 1,217,100 | 139,000 | 28,200 | 16,700^{b} |
| Engines, lbm | | | | |
| 8xGE90-115B | 154,520 | — | — | — |
| 3xRD-180 | 37,715 | — | — | — |
| 6xRS-25D | — | 46,464 | — | — |
| 4XRL(MB)-60 | — | — | 4,400 | — |
| 4xRL10(ε = 77) | — | — | — | 1,500 |
| Re-entry planform loading, lbm/ft² | — | — | — | 26.8 |
| Cargo bay, ft | — | — | — | 8 × 10 |
| Cargo density, lb/ft³ | — | — | — | 8.0 |
| Re-entry crossrange, n · mi. | — | — | — | ±4,500 |

^{a}Roundtrip: Earth-Moon surface-Earth
^{b}Incl. 15% margin

### Dual Fuel Embodiments

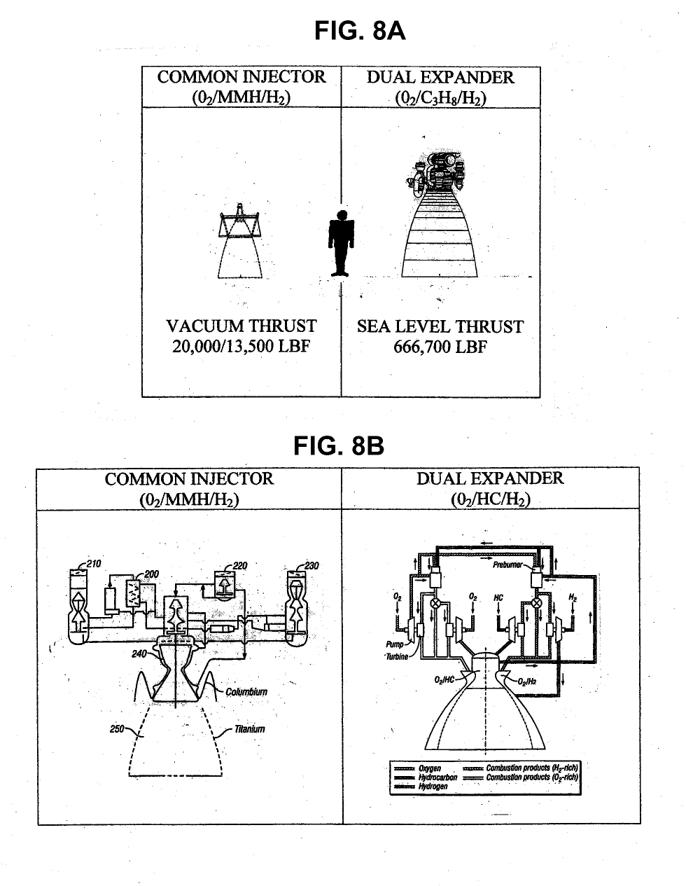

FIGS. 8A and 8B show rocket engine scale and engine cycle schematics respectively for mixed-mode, dual-fuel, tripropellant engine designs. Design data for these engines is listed in Table 9.

TABLE 9

| | ENGINE | | | |
|---|---|---|---|---|
| | | | DUAL EXPANDER | |
| | COMMON INJECTOR | | MODE 1 | MODE 2 |
| PARAMETER | O₂/MMH/H₂ | H₂ VERSION | (O₂/C₃H₈/H₂) | (O₂/H₂) |
| Thrust, sea level, lbf | N/A | N/A | 666,700 | N/A |
| Thrust, vacuum, lbf | 20,000/13,500 | 13,500 | 750,000 | 235,100 |
| Specific impulse, sea level, sec | N/A | N/A | 341 | N/A |
| Specific impulse, vacuum, sec | 393/469 | 469 | 383.7 | 462.9 |
| Chamber pressure, psia | 2,700/1,800 | 1,800 | 5,000/2,500 | 2,500 |
| Oxidizer:Fuel ratio | 1.7/7.0 | 7.0 | 3.2/6.0 | 6.0 |
| Nozzle expansion ratio | 400 | 400 | 74.8/36.3 | 119.9 |
| Engine dry mass, lbm | | | | |
| Fixed nozzle | 310 | 270 | 8,127 | 8,127 |
| Rolling nozzle | 340 | 300 | N/A | N/A |

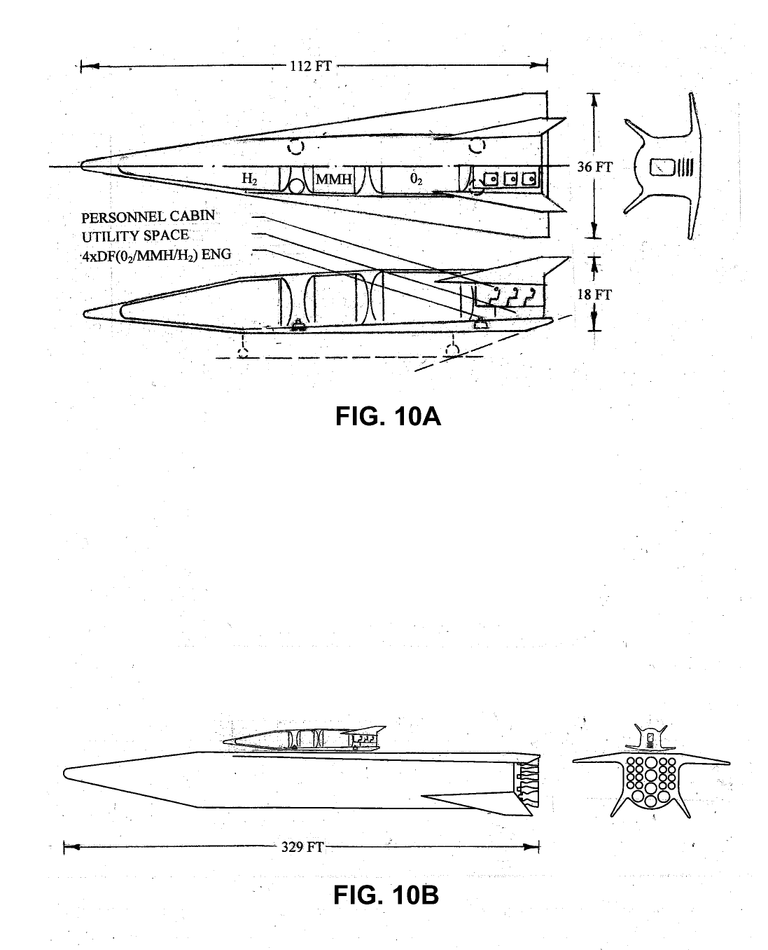

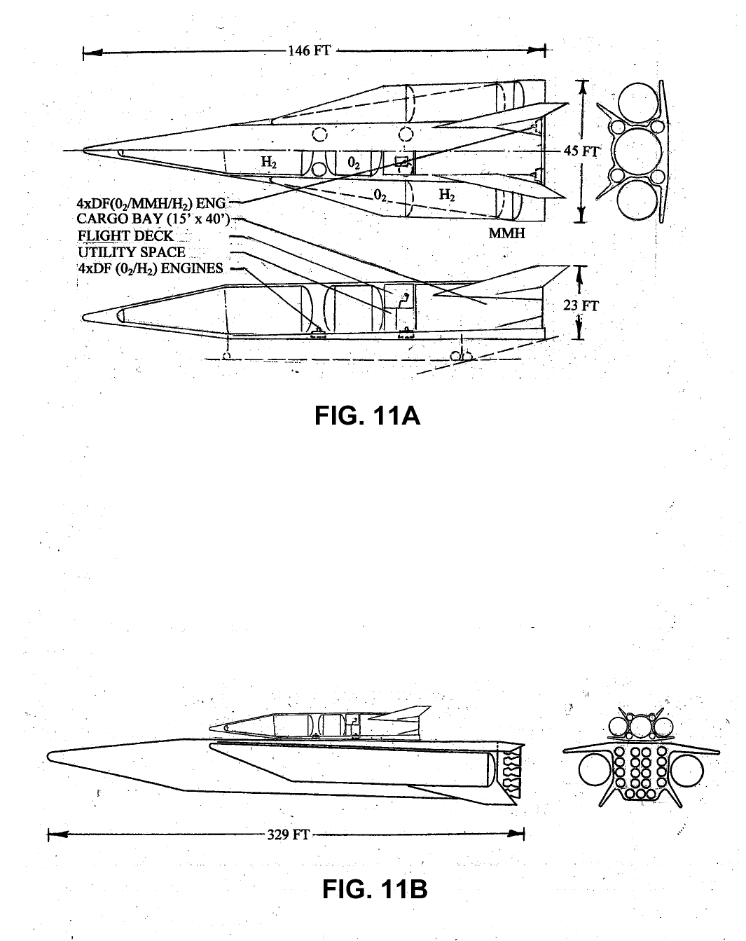

The embodiment shown in FIG. 9 concept uses dual-fuel “space engines” as shown in FIG. 8 and preferably combines four novel features: 1) ventral propulsion; 2) assembly in MTO; 3) reverse use of dual-fuel engines; and 4) use of skids for Moon and Earth landing, reducing weight, complexity and vulnerability to mechanical clogging by Moon dust. Reverse use of dual-fuel engines (i.e. reversing the burn sequence of the “space engines” as defined in FIG. 8 and Table 9 from the typical first burn of monomethyl hydrazine (MMH) and subsequent hydrogen (H₂) burn to instead burn H₂ first, then MMH, offers the improvement of extending mission stay time on the lunar surface. This is because the MMH tank can be insulated to essentially eliminate boiloff, which is not true for H2 under lunar surface temperature and vacuum conditions. Thus the hydrogen is exhausted for Moon landing, so that only storable propellants remain for Moon liftoff and escape and hydrogen boiloff is avoided during Moon surface stay time. As used throughout the specification and claims, the term “reverse use mode” means a dual fuel engine burning a first fuel during landing on the moon, the first fuel subject to boiloff on the lunar surface, and saving a second fuel for lunar take off and escape, the second fuel stored in tanks insulated to prevent boiloff of the second fuel on the lunar surface. The embodiment shown in FIG. 10 also uses the dual-fuel “space engines” for the geolunar shuttle stage and existing single fuel engines for the RGL. Both stages are fully reusable. The embodiment shown in FIG. 11 uses both axial and ventral dual-fuel “space engines” for the geolunar shuttle stage as shown in FIG. 8 and Table 9, scaled up to provide forty percent more thrust, and dual-fuel “liftoff engines” for the RGL. Vehicle parameters for the embodiments shown in FIGS. 9A, 10, and 11 are listed in Tables 10-12, respectively.

TABLE 10

VEHICLE ELEMENT

| | | EXTERNAL |
|---|---|---|
| PARAMETER | CORE | TANKS |
| Personnel (4) | 1,000 | — |
| ECLSS (10 days) | 2,000 | — |
| Mission equipment | 2,000 | — |
| Gross start weight, lbm | 64,700 | 30,600 |
| Dry weight, lbm | 18,200* | — |
| Engines | 4xO₂/MMH/H₂ | 1,200 |
| Re-entry planform loading, | 26.8 | — |
| (w/4 crew), lbm ft² | | |
| Re-entry cross range, n · mi. | ±4,500 | — |

*Incl. 15% margin

TABLE 11

| | VEHICLE | |
|---|---|---|
| | REUSABLE | |
| | GLOBAL | GEOLUNAR |
| PARAMETER | LAUNCHER | SHUTTLE |
| Payload capability^{a}, lbm | 302,000 (nom.) | |
| Crew (6), lbm | — | 1,500 |
| Mission equipt., lbm | — | 1,000 |
| Gross liftoff mass, lbm | 7,305,318 | 301,001 |
| Dry mass less engines^{b}, lbm | 368,460 | 30,841 |
| Engines (lbm) | | |
| 8xRD-180 | 48,060 | — |
| 6xRS-25 | 43,218 | — |
| 4xDF(O₂/MMH/H₂); F_{vac} = 13.5 Klbm | — | 1,360 |
| Re-entry planform loading, lbm/ft² | 30.1 | 17.1 |
| Return glide downrange, n · mi. | (global) | (global) |
| Return glide crossrange, n · mi. | ±3,500 | |

^{a}50 × 100 n · mi., 28.7°;
^{b}Incl. 15% margin

TABLE 12

| | VEHICLE | | | |
|---|---|---|---|---|
| | | | GEOLUNAR SHUTTLE | |
| | REUSABLE GLOBAL LAUNCHER | | | DROP |
| PARAMETER | CORE | | CORE | TANKS (2) |
| Payload capability^{a}, lbm | 735,000 (nom.) | — | — | — |
| Crew (2), lbm | — | — | 500 | — |
| Cargo, Earth→Moon.return, lbm | — | — | 50,000/35,000 | — |
| Gross liftoff mass, lbm | 7,099,778 | 2,731,305 | 726,866 | 408,076 |
| Dry mass less engines^{b}, lbm | 382,430 | 109,900 | 51,270 | 15,318 |
| Engines, lbm | | | | |
| 19xDF/DX(O₂/C₃H₈/H₂); Fₛₗ = 750 Klbm | 154,473 | — | — | — |
| 4xDF(O₂/MMH/H₂); F_{vac} = 13.5 Klbm | — | — | 1,870 | — |
| 4xDF(O₂/H₂ version); F_{vac} = 19 Klbm | — | — | 1,650 | — |
| Re-entry planform loading, lbm/ft² | 31.8 | — | 14.1 | — |
| Cargo bay, ft | — | — | 15 × 40 | — |
| Cargo density, lbm/ft³ | — | — | 7.1/5.0 | — |
| Return glide downrange, n · mi. | (global) | — | (global) | — |
| Return glide crossrange, n · mi. | ±3,500 | — | ±4,500 | — |

^{a}50 × 100 n · mi., 28.7°;
^{b}Incl. 15% margin

Embodiments of the geolunar shuttle of the present invention preferably utilize controllable throttling. To attain descent and ascent trajectories through the lunar gravity field, and soft landing at a precisely selected target site, the vehicle preferably comprises specialized electronic hardware and software to control throttleable main engines, such as the RL10-B2. There is preferably a provision for manual override for emergencies, and the system preferably enables final adjustments during touchdown. A controllable throttling system is typically not needed for vehicles not landing on the moon.

Although the invention has been described in detail with particular reference to the disclosed embodiments, other embodiments can achieve the same results. Variations and modifications of the present invention will be obvious to those skilled in the art and it is intended to cover all such modifications and equivalents. The entire disclosures of all patents, references, and publications cited above are hereby incorporated by reference.

What is claimed is:

1. A method for performing spaceflight, the method comprising:
launching a reusable vehicle for traveling to the moon and returning to earth on a first launcher;
launching pre-filled propellant tanks on a second launcher; and
combining the vehicle and the propellant tanks in or beyond earth orbit.

2. The method of claim 1 wherein the combining step is performed in low earth orbit (LEO) or moon transfer orbit (MTO).

3. The method of claim 1 wherein the amount of propellant in the propellant tanks is sufficient to enable the vehicle to land on the moon's surface, lift off from the moon's surface, and return to the earth's surface without refueling.

4. The method of claim 1 further comprising throttling throttleable engines of the vehicle during lunar descent.

5. The method of claim 1 comprising the vehicle landing in a horizontal attitude on the moon and/or earth using ventral propulsion.

6. The method of claim 1 wherein the vehicle is ventrally propelled for moon takeoff and landing, and axially propelled for injection into MTO.

7. The method of claim 1 comprising operating dual fuel engines in reverse use mode.

8. The method of claim 1 comprising landing the vehicle on skids.

9. The method of claim 1 wherein the first launcher and/or the second launcher comprises a Delta IV Heavy Launcher.

10. A vehicle for landing on and taking off from the moon, the vehicle comprising dual fuel engines operated in reverse use mode.

11. The vehicle of claim 10 comprising external tanks capable of holding sufficient propellant to enable the vehicle to land on the moon's surface, take off from the moon's surface, and return to the earth's surface.

12. The vehicle of claim 10 comprising one or more throttleable engines and a controllable throttling system.

13. The vehicle of claim 10 launchable from a Space Launch System (SLS), a reusable global launcher, an air launch platform, or a sea launch platform.

14. The vehicle of claim 10 wherein the vehicle is the payload of a two stage expendable launch vehicle.

15. The vehicle of claim 10 comprising ventral propulsion for horizontal attitude landing on the moon and/or earth.

16. The vehicle of claim 10 ventrally propelled for moon takeoff and landing, and axially propelled for injection into MTO.

17. The vehicle of claim 10 comprising skids for landing.

18. A vehicle for use as a booster, the vehicle comprising an aircraft launchable at sea, the aircraft having sufficient thrust to provide a 45° launch for a payload at an altitude greater than 30,000 feet.

19. The vehicle of claim 18 comprising pontoons sufficient to provide flotation for a seaplane weighing over four million pounds.

20. The vehicle of claim 18 comprising one or more rocket engines.

21. The vehicle of claim 20 comprising three tail-mounted RD-180 rocket engines.

22. The vehicle of claim 18 configured to be fueled and serviced from shipborne or submarine facilities.

23. The vehicle of claim 18 wherein the payload comprises a spacecraft, a geolunar shuttle, a ballistic missile, a cruise missile, or a drone.
